(19) United States
(12) Patent Application Publication
(10) Pub. No.: US 2020/0037808 A1
(43) Pub. Date: Feb. 6, 2020

(54) IN-VEHICLE COFFEE MAKER ASSEMBLY

(71) Applicant: Vivian Natta, Bronx, NY (US)

(72) Inventor: Vivian Natta, Bronx, NY (US)

(21) Appl. No.: 16/052,199

(22) Filed: Aug. 1, 2018

(51) Int. Cl. A47J 31/00; B60R 16/08; F02G 5/00; A47J 31/54

(52) U.S. Cl. CPC A47J 31/005; A47J 31/542; F02G 5/00; B60R 16/08

(57) ABSTRACT

A in-vehicle coffee maker assembly for brewing a cup of coffee in a vehicle includes a vehicle that has an internal combustion engine. A water reservoir is coupled to the vehicle and the water reservoir is positioned in an engine compartment of the vehicle. The water reservoir contains potable water and the water reservoir is in thermal communication with the internal combustion engine. Thus, the internal combustion engine heats the potable water in the water reservoir when the internal combustion engine is running. A coffee maker is integrated into the vehicle. The coffee maker is in fluid communication with the water reservoir such that the coffee maker receives the potable water for brewing coffee.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to coffee maker devices and more particularly pertains to a new coffee maker device for brewing a cup of coffee in a vehicle.

### BRIEF SUMMARY OF THE INVENTION

An embodiment of the disclosure meets the needs presented above by generally comprising a vehicle that has an internal combustion engine. A water reservoir is coupled to the vehicle and the water reservoir is positioned in an engine compartment of the vehicle. The water reservoir contains potable water and the water reservoir is in thermal communication with the internal combustion engine. Thus, the internal combustion engine heats the potable water in the water reservoir when the internal combustion engine is running. A coffee maker is integrated into the vehicle. The coffee maker is in fluid communication with the water reservoir such that the coffee maker receives the potable water for brewing coffee.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a water reservoir and a coffee maker of an in-vehicle coffee maker assembly according to an embodiment of the disclosure.

FIG. 2 is a front view of coffee maker of an embodiment of the disclosure.

FIG. 3 is a right side view of water reservoir and a coffee maker of an embodiment of the disclosure.

FIG. 4 is a perspective in-use view of an embodiment of the disclosure.

FIG. 5 is a right side phantom view of water reservoir and a coffee maker of an embodiment of the disclosure.

### DETAILED DESCRIPTION OF THE INVENTION

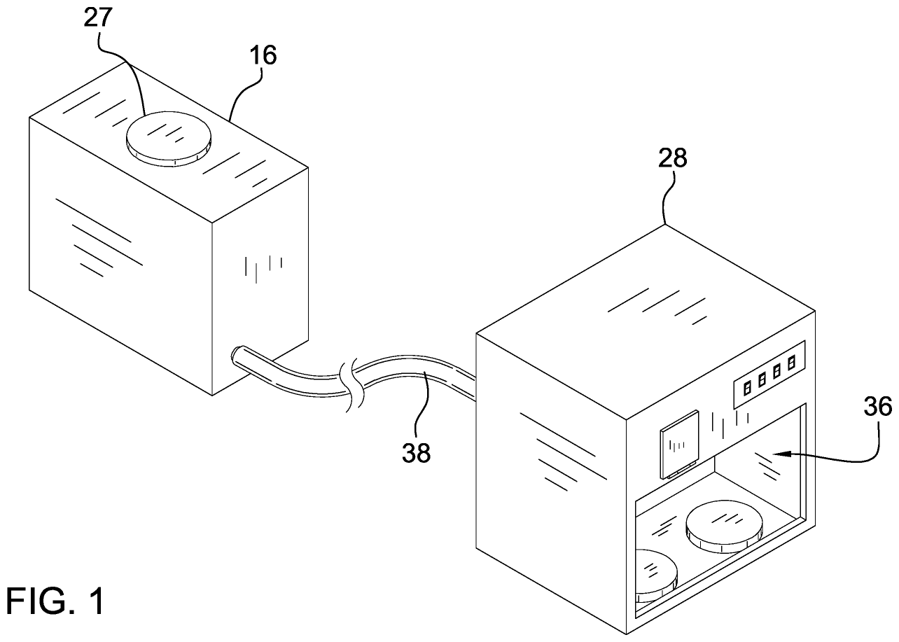

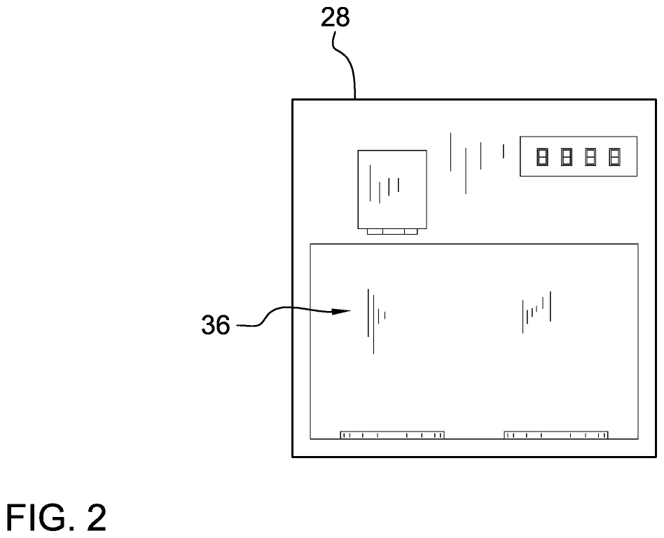

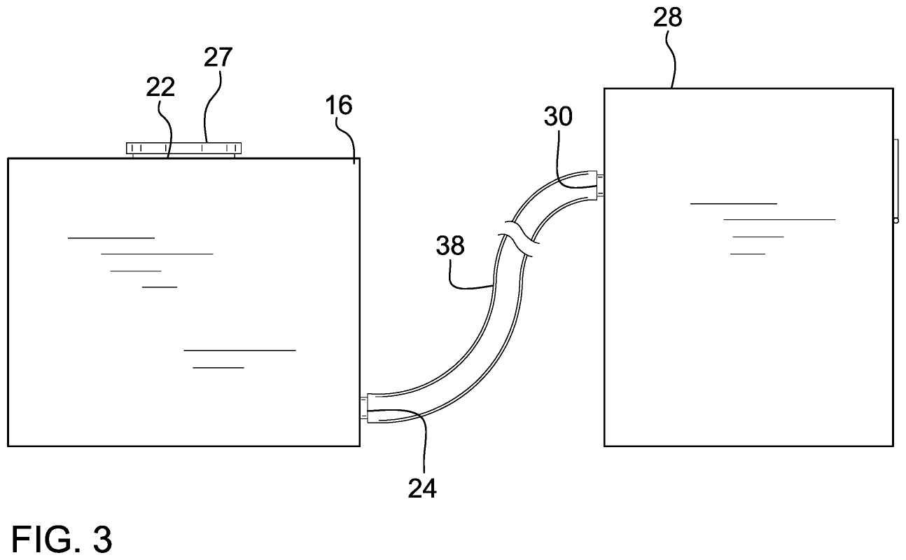

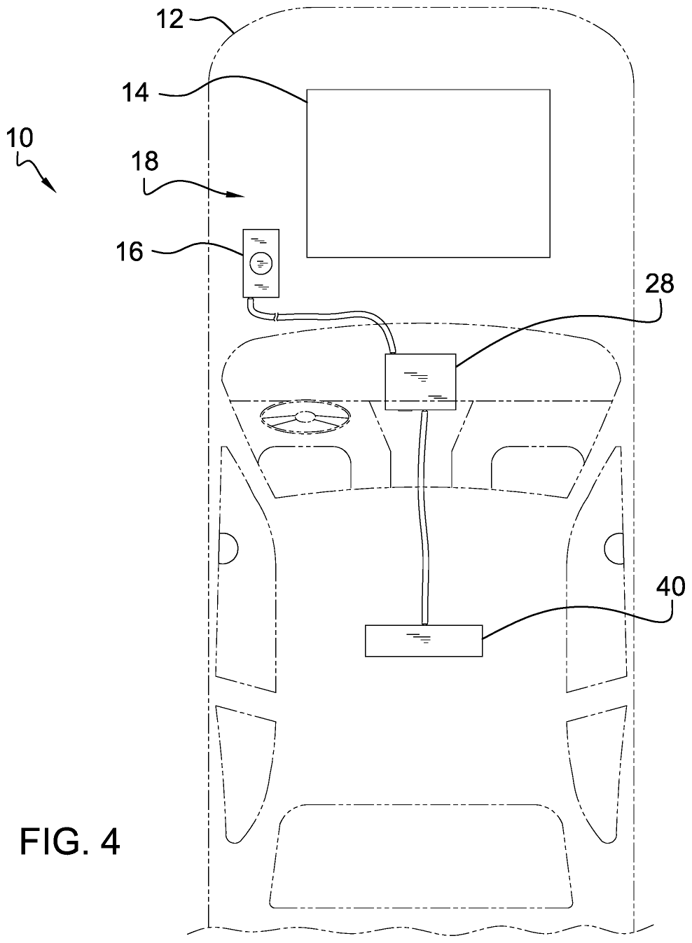

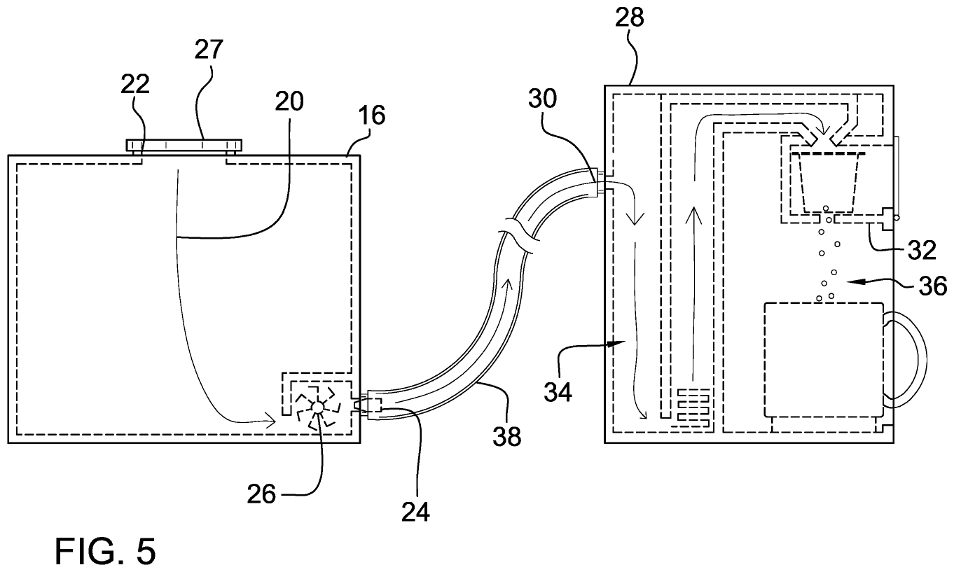

With reference now to the drawings, and in particular to FIGS. 1 through 5 thereof, a new coffee maker device embodying the principles and concepts of an embodiment of the disclosure and generally designated by the reference numeral 10 will be described.

As best illustrated in FIGS. 1 through 5, the in-vehicle coffee maker assembly 10 generally comprises a vehicle 12 that has an internal combustion engine 14. The vehicle 12 may be a passenger vehicle 12, a cargo vehicle 12 and any other motor vehicle 12. A water reservoir 16 is coupled to the vehicle 12 and the water reservoir 16 is positioned in an engine compartment 18 of the vehicle 12. The water reservoir 16 contains potable water 20 and the water reservoir 16 is independent of a radiator, a de-gas bottle, a windshield wiper fluid reservoir and any other fluid reservoir involved with the operation of the vehicle 12. The water reservoir 16 is in thermal communication with the internal combustion engine 14 such that the internal combustion engine 14 heats the potable water 20 in the water reservoir 16 when the internal combustion engine 14 is running. The thermal communication between the water reservoir 16 and the internal combustion engine 14 may be accomplished with a heat exchanger that is in fluid communication with a cooling system of the vehicle 12, the water reservoir 16 may be placed directly against the engine block of the internal combustion, or any other conventional means.

The water reservoir 16 has a fill port 22 and an output 24, and a pump 26 is positioned in the water reservoir 16. The pump 26 is fluidly coupled to the output 24 such that the pump 26 urges the potable water 20 outwardly through the output 24 when the pump 26 is turned on. The pump 26 is electrically coupled to a power source comprising an electrical system of the vehicle 12. The pump 26 may be an electrical fluid pump or the like that is common to electronic coffee makers. A lid 27 is removably coupled to the fill port 22 on the water reservoir 16 for closing the fill port 22.

A coffee maker 28 is integrated into the vehicle 12 and the coffee maker 28 has a fluid input 30, a basket 32 and a conduit 34 that is in fluid communication between the fluid input 30 and the basket 32. The coffee maker 28 has a cup well 36 therein for insertably receiving a cup, such as a coffee cup or other beverage container. The cup well 36 is aligned with the basket 32 such that the cup receives coffee from the basket 32. A hose 38 is fluidly coupled between the output 24 on the reservoir and the input on the coffee maker 28 such that the hose 38 delivers the potable water 20 to the coffee maker 28 for brewing the coffee. The coffee maker 28 may be a pod based coffee maker of any conventional design that has been integrated into the vehicle 12 during manufacturing. The coffee maker 28 may include electronic controls that are conventional to electronic coffee makers and the pump 26 may be electrically coupled to the coffee maker 28 for controlling the pump 26.

In use, the water reservoir 16 is filled with potable water 20 prior to driving the vehicle 12. The internal combustion engine 14 heats the water reservoir 16 when the internal combustion engine 14 is running. Thus, the coffee maker 28 has a supply of hot water for brewing a cup of coffee while the vehicle 12 is being driven. In this way a driver, or a passenger, can enjoy a freshly brewed, hot cup of coffee during trips without requiring stopping at a gas station or the like to purchase coffee. A storage reservoir 40 is positioned in the vehicle 12 such that that storage reservoir 40 is accessible to the driver or the passenger. The storage reservoir 40 is in fluid communication with the water reservoir 16 thereby facilitating hot water to be accessible to the driver and the passenger.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An in-vehicle coffee maker assembly being in thermal communication with a motor in a vehicle for producing hot water for brewing coffee, said assembly comprising:
a vehicle having an internal combustion engine;
a water reservoir being coupled to said vehicle, said water reservoir being positioned in an engine compartment of said vehicle, said water reservoir containing potable water, said water reservoir being in thermal communication with said internal combustion engine such that said internal combustion engine heats said potable water in said water reservoir when said internal combustion engine is running; and
a coffee maker being integrated into said vehicle, said coffee maker being in fluid communication with said water reservoir such that said coffee maker receives said potable water for brewing coffee.

2. The assembly according to claim 1, further comprising:
an output being fluidly coupled to said water reservoir; and
a pump being positioned in said water reservoir, said pump being fluidly coupled to said output such that said pump urges said potable water outwardly through said output when said pump is turned on, said pump being electrically coupled to a power source comprising an electrical system of said vehicle.

3. The assembly according to claim 1, further comprising:
an output being fluidly coupled to said water reservoir;
an input being fluidly coupled to said coffee maker; and
a hose being fluidly coupled between said output on said reservoir and said input on said coffee maker such that said hose delivers said potable water to said coffee maker for brewing the coffee.

4. An in-vehicle coffee maker assembly being in thermal communication with a motor in a vehicle for producing hot water for brewing coffee, said assembly comprising:
a vehicle having an internal combustion engine;
a water reservoir being coupled to said vehicle, said water reservoir being positioned in an engine compartment of said vehicle, said water reservoir containing potable water, said water reservoir being in thermal communication with said internal combustion engine such that said internal combustion engine heats said potable water in said water reservoir when said internal combustion engine is running, said water reservoir having a fill port and an output;
a pump being positioned in said water reservoir, said pump being fluidly coupled to said output such that said pump urges said potable water outwardly through said output when said pump is turned on, said pump being electrically coupled to a power source comprising an electrical system of said vehicle;
a coffee maker being integrated into said vehicle, said coffee maker having a fluid input, a basket and a conduit being in fluid communication between said fluid input and said basket, said coffee maker having a cup well therein for insertably receiving a cup, said cup well being aligned with said basket such that said cup receives coffee from said basket; and
a hose being fluidly coupled between said output on said reservoir and said input on said coffee maker such that said hose delivers said potable water to said coffee maker for brewing the coffee.
